(19) United States
(12) Patent Application Publication
(10) Pub. No.: US 2013/0293546 A1
(43) Pub. Date: Nov. 7, 2013

(54) DYNAMIC LOAD BALANCING APPARATUS AND METHOD FOR GRAPHIC PROCESSING UNIT (GPU)

(71) Applicant: SAMSUNG ELECTRONICS CO., LTD., Suwon-si (KR)

(72) Inventors: Won Jong Lee, Suwon-si (KR); Seok Yoon Jung, Seoul (KR)

(73) Assignee: SAMSUNG ELECTRONICS CO., LTD., Suwon-si (KR)

(21) Appl. No.: 13/835,281

(22) Filed: Mar. 15, 2013

(30) Foreign Application Priority Data
May 3, 2012 (KR) 10-2012-0046930

(51) Int. Cl. G06T 1/20

(52) U.S. Cl. CPC G06T 1/20
USPC 345/426

(57) ABSTRACT

The GPU including at least one shader processor may assign a vertex shader task and a pixel shader task to the at least one shader processor.

### CROSS-REFERENCE TO RELATED APPLICATIONS

This application claims the benefit of Korean Patent Application No. 10-2012-0046930, filed on May 3, 2012, in the Korean Intellectual Property Office, the disclosure of which is incorporated herein by reference.

### BACKGROUND

1. Field

One or more example embodiments of the following description relate to an apparatus and method for graphic processing, and more particularly, to an apparatus and method for dynamically adjusting a load between shader processors.

2. Description of the Related Art

To perform rendering of an image, an object-based rendering (OBR) scheme, or a tile-based rendering (TBR) scheme may be used.

The OBR scheme may be used as a main algorithm by a graphic processing unit (GPU) of a desktop, due to ease of designing of hardware and intuitively processing, and the like.

The OBR scheme may enable rendering to be performed based on an order of the objects. Accordingly, the OBR scheme may induce a random access to an external memory for each pixel in a pixel pipeline side. The external memory may include, for example, a dynamic random access memory (DRAM).

Conversely, in the TBR scheme, a screen area may be divided into tiles, and rendering may be performed in an order of the tiles. For example, when the TBR scheme is used, an external memory may be approached only once per tile. The tiles may be rendered using a high-speed internal memory, and a result of the rendering may be transmitted to a memory.

### SUMMARY

The foregoing and/or other aspects are achieved by providing a graphic processing unit (GPU), including at least one shader processor operated as a vertex shader and a pixel shader, and a job manager to assign a vertex shader task and a pixel shader task to the at least one shader processor, wherein the at least one shader processor each interleaves and executes the assigned vertex shader task and the assigned pixel shader task.

The at least one shader processor may each process a task through a plurality of pipeline stages.

The plurality of pipeline stages may each process the assigned vertex shader task or the assigned pixel shader task.

Each of the at least one shader processor may include a vertex loader to read data of a vertex, a fragment generator to generate data of a pixel included in an object, based on data of the object, a unified shader to transform, based on the data of the vertex, a three-dimensional (3D) position of the vertex to a depth value and two-dimensional (2D) coordinates, to generate data of the transformed vertex, and to apply per-pixel effects to the data of the pixel, a primitive assembly to generate a primitive, based on the data of the transformed vertex, and a raster operator to generate a raster image, based on the data of the pixel

Each of the plurality of pipeline stages may be provided by at least one of the vertex loader, the fragment generator, the unified shader, the primitive assembly, and the raster operator.

The vertex shader task may be a task divided in a drawcall unit.

The pixel shader task may be a task divided in a tile unit.

The GPU may further include a tile dispatch unit to transmit data of an object in a tile to the at least one shader processor.

The GPU may further include a tile binning unit to divide a frame into tiles.

The job manager may manage at least one slot unit configured to store a state of each of the at least one shader processor.

The at least one slot unit may record a type of a task executed by each of the at least one shader processor.

The foregoing and/or other aspects are achieved by providing a graphic processing method, including assigning, by a job manager, a vertex shader task to a shader processor, assigning, by the job manager, a pixel shader task to the shader processor, and interleaving and executing, by the shader processor, the assigned vertex shader task and the assigned pixel shader task.

The interleaving and executing may include reading, by a vertex loader of the shader processor, data of a vertex, transforming, by a unified shader of the shader processor, based on the data of the vertex, a 3D position of the vertex to a depth value and 2D coordinates, and generating data of the transformed vertex, generating, by a primitive assembly of the shader processor, a primitive, based on the data of the transformed vertex, generating, by a fragment generator of the shader processor, data of a pixel included in an object, based on data of the object, applying, by the unified shader, per-pixel effects to the data of the pixel, and generating, by a raster operator of the shader processor, a raster image, based on the data of the pixel.

A plurality of shader processors may be provided.

The assigning of the vertex shader task may include selecting, by the job manager, a shader processor that does not process a vertex shader task, from among the plurality of shader processors, and assigning, by the job manager, the vertex shader task to the selected shader processor.

The assigning of the vertex shader task may further include identifying, by the job manager, a shader processor that does not process a vertex shader task, from among the plurality of shader processors, by checking information regarding states of the plurality of shader processors, and changing, by the job manager, information regarding a state of the selected shader processor, so that the changed information indicates that the selected shader processor processes the vertex shader task.

The assigning of the pixel shader task may include selecting, by the job manager, a shader processor that does not process a pixel shader task, from among the plurality of shader processors, and assigning, by the job manager, the pixel shader task to the selected shader processor.

The assigning of the pixel shader task may further include identifying, by the job manager, a shader processor that does not process a pixel shader task, from among the plurality of shader processors, by checking information regarding states of the plurality of shader processors, and changing, by the job manager, information regarding a state of the selected shader processor, so that the changed information indicates that the selected shader processor processes the pixel shader task.

The foregoing and/or other aspects are achieved by providing a shader processor including a vertex loader to read data of a vertex, a fragment generator to generate data of a pixel included in an object, based on data of the object, a unified shader to transform, based on the data of the vertex, a 3D position of the vertex to a depth value and 2D coordinates, to generate data of the transformed vertex, and to apply per-pixel effects to the data of the pixel, a primitive assembly to generate a primitive, based on the data of the transformed vertex, and a raster operator to generate a raster image, based on the data of the pixel.

The shader processor may be configured to process a task through a plurality of pipeline stages.

The plurality of pipeline stages may each process a vertex shader task or a pixel shader task.

Each of the plurality of pipeline stages may be provided by at least one of the vertex loader, the fragment generator, the unified shader, the primitive assembly, and the raster operator.

The foregoing and/or other aspects are achieved by providing a shader processor configured to operate as both a vertex shader and a pixel shader, wherein the shader processor comprises a core of a graphic processing unit and is controlled to interleave and execute an assigned vertex shader task and an assigned pixel shader task.

The foregoing and/or other aspects are achieved by providing a graphic processing unit (GPU). The GPU includes a first shader processor and a second shader processor, each operated as both a vertex shader and a pixel shader, and a job manager to interleave tasks by assigning either of a vertex shader task and a pixel shader task to whichever of the first shader processor and the second shader processor is idle.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a shader processor according to example embodiments;

FIG. 2 illustrates a block diagram of a graphic processing unit (GPU) according to example embodiments;

FIG. 3 illustrates graphs of an operation of a shader processor to which shader interleaving is applied, according to example embodiments;

FIG. 4 illustrates a graph of an operation of a GPU in an example in which interleaving is not applied, according to example embodiments;

FIG. 5 illustrates a graph of an operation of a GPU in an example in which interleaving is applied, according to example embodiments;

FIG. 6 illustrates a diagram of a task scheduler using slots according to example embodiments;

FIG. 7 illustrates a graph of task scheduling using slots according to example embodiments;

FIG. 8 illustrates a flowchart of a graphic processing method according to example embodiments; and

FIG. 9 illustrates a flowchart of an operation of interleaving and executing an assigned vertex shader task and an assigned pixel shader task, in the graphic processing method of FIG. 8.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

Hereinafter, the terms “pixel” and “fragment” may have the same meanings, and may be interchangeably used.

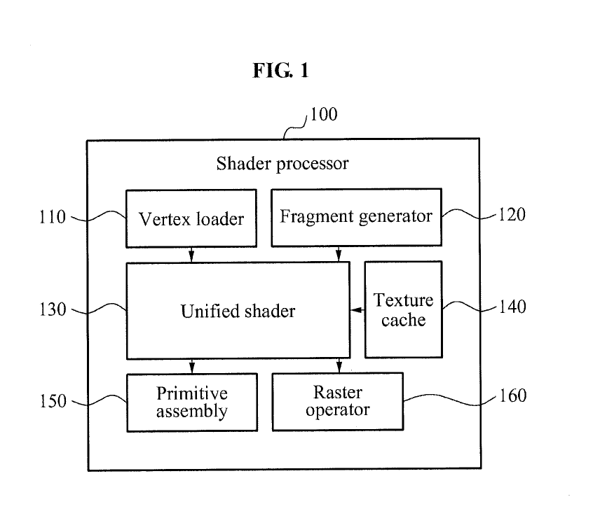

FIG. 1 illustrates a block diagram of a shader processor 100 according to example embodiments.

The shader processor 100 of FIG. 1 may include, for example, a vertex loader 110, a fragment generator 120, a unified shader 130, a texture cache 140, a primitive assembly 150, and a raster operator 160.

The shader processor 100 may be a core of a graphic processing unit (GPU).

The shader processor 100 may function as a vertex shader and a pixel shader. The shader processor 100 may perform a function of a vertex shader processor, and a function of a pixel shader processor. In the shader processor 100, hardware used to process a vertex, and hardware used to process a pixel may coexist. The shader processor 100 may execute a code used to process a vertex, and a code used to process a pixel.

A shader, or a code of the shader may refer to a set of software instructions. The shader may be used primarily to calculate rendering effects on graphics hardware. Additionally, the shader may be used to program a programmable rendering pipeline of the GPU.

In an example, when the shader processor 100 functions as a vertex shader, the vertex loader 110, the unified shader 130, and the primitive assembly 150 may process a vertex shader task. The unified shader 130 may perform a function of the vertex shader.

In another example, when the shader processor 100 functions as a pixel shader, the fragment generator 120, the unified shader 130, and the raster operator 160 may process a pixel shader task. The unified shader 130 may perform a function of the pixel shader.

In this instance, the vertex shader task may refer to a task of a vertex shader that may be processed by a typical vertex shader. Additionally, the vertex shader task may further include a tessellation shader task, and a geometry shader task. The pixel shader task may refer to a task of a pixel shader that may be processed by a typical pixel shader.

The vertex loader 110 may read data of a vertex. The vertex loader 110 may load the data of the vertex from a memory and the like, via a system bus for example. The data of the vertex may include information on the vertex.

The unified shader 130 may transform, based on the data of the vertex, a three-dimensional (3D) position in virtual space of the vertex to a depth value and two-dimensional (2D) coordinates at which the vertex is to appear on a screen, and may generate data of the transformed vertex. In this instance, the depth value may be a depth value for a Z-buffer. The unified shader 130 may be used once for each vertex given to the shader processor 100.

The primitive assembly 150 may generate a viable primitive, based on the data of the vertex output from the unified shader 130. To use the data of the vertex, the primitive assembly 150 may collect runs of the data of the vertex output from the unified shader 130. The primitive may include at least one of a line, a point, and a triangle.

The fragment generator 120 may generate data of a pixel included in an object, based on data of the object. In this instance, the object may include a primitive, such as a triangle and the like. The fragment generator 120 may interpolate texture coordinates, screen coordinates and the like that are defined in each vertex in the primitive, and may generate data of a pixel in a vertex.

The unified shader 130 may apply per-pixel effects to the generated data of the pixel. The unified shader 130 may apply complex per-pixel effects to each of generated pixels by performing a code implemented by a shader programmer.

The unified shader 130 may calculate texture mapping, reflection of light, and the like, and may calculate a color of a pixel. Additionally, the unified shader 130 may eliminate a predetermined pixel using a discard instruction.

The raster operator 160 may perform a depth test, color blending, and the like, and may generate a raster image based on the data of the pixel. In this instance, the raster image may include, for example, pixels or dots.

The texture cache 140 may cache data of a texture from a memory or another cache outside the shader processor 100, and may provide the cached data to the unified shader 130.

A vertex shader task and a pixel shader task may be assigned to the shader processor 100. The shader processor 100 may interleave and execute the assigned vertex shader task and the assigned pixel shader task.

The shader processor 100 may process a task through a plurality of pipeline stages. In this instance, at least one vertex shader task and/or at least one pixel shader task may be processed. The pipeline stages may each process a vertex shader task or a pixel shader task that is assigned to the shader processor 100.

Each of the pipeline stages may be provided by at least one of the vertex loader 110, the fragment generator 120, the unified shader 130, the primitive assembly 150, and the raster operator 160. The shader processor 100 may process a plurality of tasks in parallel, using a pipeline provided by at least one of the vertex loader 110, the fragment generator 120, the unified shader 130, the primitive assembly 150, and the raster operator 160.

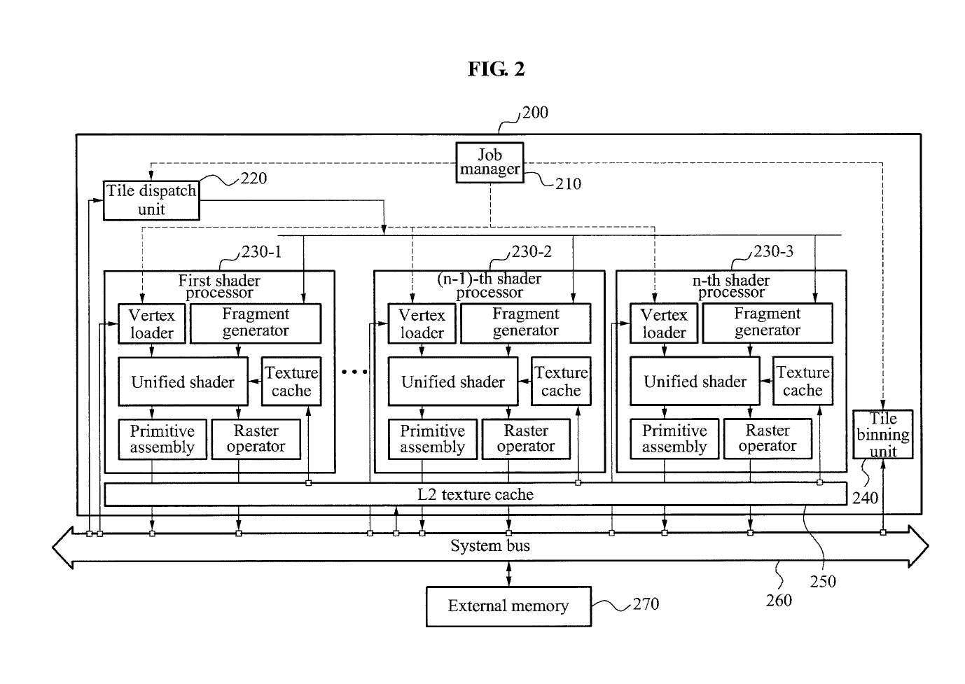

FIG. 2 illustrates a block diagram of a GPU 200 according to example embodiments.

The GPU 200 may provide a parallel tile-based rendering (TBR) architecture that employs the shader processor 100 of FIG. 1.

As shown in FIG. 2, the GPU 200 may include, for example, a job manager 210, a tile dispatch unit 220, at least one shader processor, a tile binning unit 240, and an L2 texture cache 250.

The at least one shader processor may be, for example, the shader processor 100 of FIG. 1. Accordingly, the above description of the shader processor 100 of FIG. 1 may be applied to each of the at least one shader processor. As shown in FIG. 2, the at least one shader processor may include, for example, a first shader processor 230-1, an (n−1)-th shader processor 230-2, an n-th shader processor 230-3, and the like. In this instance, ‘n’ may represent a number of shader processors, and may be an integer that is greater than ‘1.’

The at least one shader processor may be a plurality of identical shader processor cores. In an alterative embodiment, the at least one shader processor may have at least one difference from each other.

Each of the at least one shader processor may function as a vertex shader and a pixel shader, for dynamic load balancing.

In FIG. 2, a solid-line arrow may represent movement of data between components included in the GPU 200, and a dotted-line arrow may represent that a component from which the arrow originates may control a component at which the arrow arrives.

The job manager 210 may assign a vertex shader task and a pixel shader task to the at least one shader processor. For example, the job manager 210 may assign a predetermined vertex shader task or a predetermined pixel shader task to a shader processor selected from among the at least one shader processor. The job manager 210 may select a shader processor that may process a vertex shader task or a pixel shader task, from among the at least one shader processor. The job manager 210 may control each of the at least one shader processor to be operated as at least one of a vertex shader and a pixel shader.

The job manager 210 may divide a job into tasks, and may transmit each of the tasks to an appropriate shader processor among the at least one shader processor. In an embodiment, the appropriate shader processor may be an idle shader processor.

The job manager 210 may receive graphic commands from a host, for example, a central processing unit (CPU). The job manager 210 may store the received graphic commands, and may generate a task suitable for one of the graphic commands. The job manager 210 may assign the generated task to an appropriate shader processor among the at least one shader processor. In this instance, the assigning of the task may indicate transmitting data of the task to the appropriate shader processor.

To determine the appropriate shader processor, the job manager 210 may check a state of each of the at least one shader processor. The job manager 210 may preferentially assign a task to an idle shader processor, and may provide dynamic load balancing.

The vertex shader task may be a task divided in a drawcall unit. The pixel shader task may be a task divided in a tile unit. Additionally, the job manager 210 may process a tile binning task, a tessellation shader task, a computation shader task, and the like.

The tile dispatch unit 220 may transmit data of an object in a tile to a shader processor selected from among the at least one shader processor. In this instance, the object may be a primitive, such as a triangle and the like. Specifically, the tile dispatch unit 220 may distribute each of the tiles in a frame to a shader processor selected from among the at least one shader processor. A single shader processor may be selected by the job manager 210. For example, when a pixel shader task is assigned to the at least one shader processor, the job manager 210 may control the tile dispatch unit 220 to transmit the data of the object in the tile to the selected shader processor.

The tile binning unit 240 may manage all of the at least one shader processor that may be operated as a vertex shader.

The tile binning unit 240 may divide a frame into tiles. The dividing of the frame may refer to tiling of TBR. The tile binning unit 240 may determine which object is included in each of the tiles into which the frame is divided, and may generate data of an object in a tile by separating the object as the tile including the object. The job manager 210 may control the tile binning unit 240 to divide a frame into tiles.

The vertex loader 110, the primitive assembly 150, and the unified shader 130 that is operated as a vertex shader, may process a vertex in a frame. When the vertex is processed, the tile binning unit 240 may divide the frame into tiles. The tile dispatch unit 220, the fragment generator 120, the raster operator 160, and the unified shader 130 that is operated as a pixel shader, may process a pixel or a primitive in each of the tiles into which the frame is divided.

The L2 texture cache 250 may cache data of a texture from an external memory 270, and may provide the cached data to the texture cache 140 of the shader processor 100. The texture cache 140 may refer to a texture cache of level 1 to provide the data of the texture directly to the unified shader 130, and the L2 texture cache 250 may refer to a texture cache of level 2 to provide the data of the texture to the unified shader 130 through the texture cache 140.

The external memory 270 may store data generated by the GPU 200, and may provide data to the GPU 200.

A system bus 260 of FIG. 2 may refer to a transmission channel that enables transmission of data. For example, the system bus 260 may enable data to be transmitted between components included in the GPU 200, and enable data to be transmitted between a component in the GPU 200 and the external memory 270.

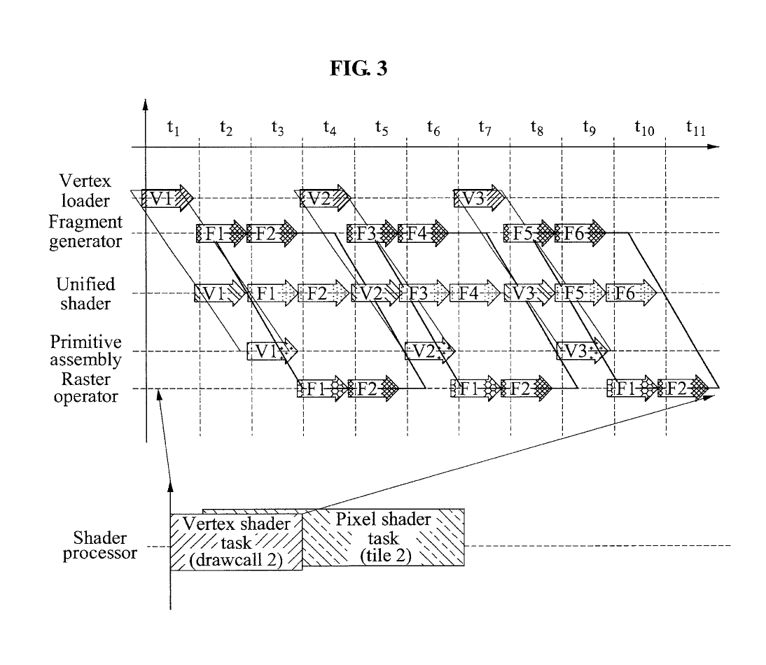

FIG. 3 illustrates graphs of an operation of a shader processor to which shader interleaving is applied, according to example embodiments.

As shown in a bottom graph, the shader processor 100 may interleave and execute a vertex shader task ‘drawcall 2’ and a pixel shader task ‘tile 2.’ In the bottom graph, an x-axis may represent passage of time.

As shown in a top graph, elements included in the shader processor 100 may interleave and execute a vertex shader task ‘drawcall 2’ and a pixel shader task ‘tile 2’ through pipelining. The top graph may represent an operation of each of the elements over time while the shader processor 100 executes the vertex shader task ‘drawcall 2.’ In the top graph, a y-axis may represent each of the elements, and an x-axis may represent time. Additionally, in the top graph, ‘V’ may represent execution associated with a vertex shader task, and ‘F’ may represent execution associated with a pixel shader task. A numeral next to ‘V’ may represent interrelated executions.

For example, ‘V1’ in time ‘t₁’ may indicate that the vertex loader 110 reads data of a vertex, and ‘V1’ in time ‘t₂’ may indicate that the unified shader 130 generates data of the vertex transformed based on the data of the vertex. Additionally, ‘V1’ in time ‘t₃’ may indicate that the primitive assembly 150 generates a primitive based on the data of the transformed vertex. In FIG. 3, the vertex shader task ‘drawcall 2’ may be divided into ‘V1’, ‘V2’ and ‘V3,’ and may be executed. In other words, ‘V1’, ‘V2’ and ‘V3’ may each represent a data stream forming the vertex shader task ‘drawcall 2.’

For example, ‘F1’ in time ‘t₂’ may indicate that the fragment generator 120 generates data of a pixel included in an object, based on data of the object. Additionally, ‘F1’ in time ‘t₃’ may indicate that the unified shader 130 applies per-pixel effects to the data of the pixel. In addition, ‘F1’ in time ‘t₄’ may indicate that the raster operator 160 generates a raster image based on the data of the pixel to which the per-pixel effects are applied. In FIG. 3, the pixel shader task ‘tile 2’ may be divided into ‘F1’, ‘F2’, ‘F3’, ‘F4’, ‘F5’ and ‘F6,’ and may be executed.

In the time ‘t₃,’ the fragment generator 120 and the unified shader 130 may execute the pixel shader task ‘tile 2,’ and the primitive assembly 150 may execute the vertex shader task ‘drawcall 2.’ Accordingly, the vertex shader task ‘drawcall 2’ and the pixel shader task ‘tile 2’ may be interleaved with each other and may be executed.

For example, when only the pixel shader task ‘tile 2’ is executed by the shader processor 100, instead of the vertex shader task ‘drawcall 2’ and the pixel shader task ‘tile 2’ being interleaved with each other, a pipeline bubble may occur in a pipeline. Hereinafter, the pipeline bubble may be briefly referred to as a ‘bubble.’

In execution of a task, a code and hardware of the unified shader 130 may be operated in a data stream unit or in a batch unit. The batch may refer to a basic processing unit of data, for example 100 draws.

When stages of a pipeline are different in latency from each other, a bubble may occur in the pipeline. The latency may refer to a delay time consumed to execute stages. The bubble may refer to a situation in which a shader waits for a next data stream or a next batch, since a code of a unified shader is terminated earlier than processing of hardware. Such a waiting may be caused by a fixed execution time of the hardware as a fixed function block, compared to when a shader written by a developer has a variant complexity and execution time.

For example, when each of ‘V1’, ‘V2’ and ‘V3’ represents ‘glDraw*’, and when a number of input primitives is equal to or less than a predefined stream size, pipelines of each of ‘V1’, ‘V2’ and ‘V3’ may be arranged in series. In this instance, the number of the input primitives may refer to a number of primitives that need to be processed in a single task. The serialization may indicate that an operation of ‘V2’ is started after all operations of ‘V1’ are completed, and that an operation of ‘V3’ is started after all operations of ‘V2’ are completed. When serialization occurs, a bubble may exist until a single data stream and a next data stream are processible sequentially by the unified shader 130. In FIG. 3, when the shader processor 100 executes only the vertex shader task ‘drawcall 2’, the unified shader 130 may be in the idle state in the times ‘t₃’ and ‘t₄’, until ‘V1’ is processible in the time ‘t₂’ and ‘V2’ is processible in a time ‘t₅’.

When a state of the unified shader 130 is switched to a standby state due to the above bubble, and when the unified shader 130 enables execution of a code of a shader instead of stalling the code, an effect of hiding a latency may be created. In other words, a vertex shader task and a pixel shader task may be interleaved with each other and may be executed, and accordingly the elements of the shader processor 100 may execute, in parallel, the vertex shader task and the pixel shader task. Additionally, a tessellation shader task and a geometry shader task may be interleaved with the pixel shader task, and may be executed.

For example, when the vertex shader task ‘drawcall 2’ and the pixel shader task ‘tile 2’ are interleaved and executed, the unified shader 130 may execute ‘F1’ and ‘F2’ in the times ‘t₃’ and ‘t₄’, respectively, that is, may not enter the idle state.

When the unified shader 130 processes different tasks over time, context information of the tasks may be used. A unified shader of each of the at least one shader processor may separately store context information in the unified shader or in an internal memory of each of the at least one shader processor. For example, when context information is stored in the unified shader 130 or the shader processor 100, an overhead caused by context switching may be removed or reduced.

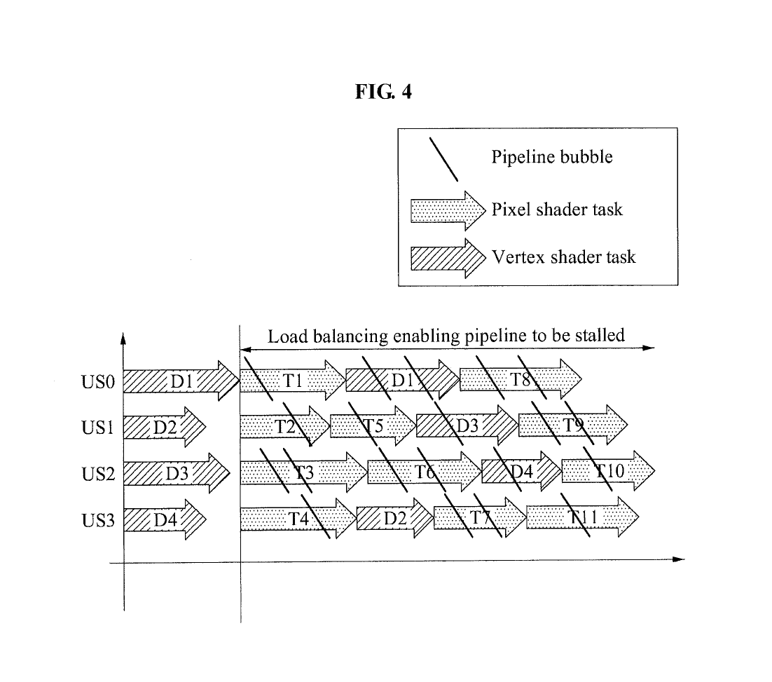

FIG. 4 illustrates a graph of an operation of a GPU in an example in which interleaving is not applied, according to example embodiments.

In the graph of FIG. 4, a y-axis may represent unified shaders, for example four unified shaders ‘US0’, ‘US1’, ‘US2’ and ‘US3’, and an x-axis may represent passage of time.

Additionally, in the graph of FIG. 4, an arrow may represent a task. Based on a pattern in an arrow, a pixel shader task and a vertex shader task may be distinguished. An arrow with a diagonal line may indicate that a bubble occurs when a unified shader processes a task indicated by the arrow.

A left side of the graph may represent vertex shader tasks that are to be processed by the GPU 200, for example vertex shader tasks ‘D1’, ‘D2’, ‘D3’ and ‘D4’. In this instance, ‘D’ may denote a ‘drawcall’.

A right side of the graph may represent tasks processed by each of the unified shaders ‘US0’, ‘US1’, ‘US2’ and ‘US3’ over time. For example, the unified shader ‘US0’ may sequentially process a pixel shader task ‘T1’, a vertex shader task ‘D1’ and a pixel shader task ‘T8’. In this instance, ‘T’ indicating a pixel shader task may refer to a ‘tile’.

The job manager 210 may identify a unified shader that completes processing of a task, from among the unified shaders ‘US0’ through ‘US3’, and may assign a next task to a shader processor of the identified unified shader. For example, the unified shader ‘US1’ among the unified shaders ‘US0’ through ‘US3’ may complete, first, execution of a pixel shader task ‘T2’ assigned to the unified shader ‘US1’. The job manager 210 may assign a next task, namely, a pixel shader task ‘T5’ to a shader processor of the unified shader ‘US1’.

In FIG. 4, a single unified shader may process only a single task at a time. In other words, load balancing provided by the job manager 210 may refer to assigning only a single task to a single unified shader at a time. Due to the load balancing, a pipeline may be stalled.

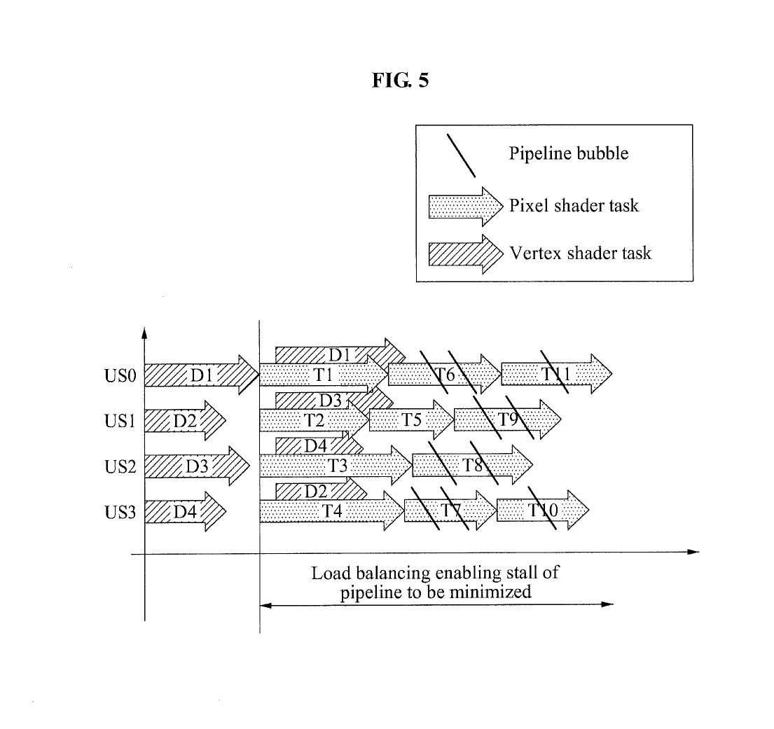

FIG. 5 illustrates a graph of an operation of a GPU in an example in which interleaving is applied, according to example embodiments.

In the graph of FIG. 5, a y-axis may represent unified shaders, for example four unified shaders ‘US0’, ‘US1’, ‘US2’ and ‘US3’, and an x-axis may represent passage of time.

Additionally, in the graph of FIG. 5, an arrow may represent a task. Based on a pattern in an arrow, a pixel shader task and a vertex shader task may be distinguished. An arrow with a diagonal line may indicate that a bubble occurs when a unified shader processes a task indicated by the arrow.

A left side of the graph may represent vertex shader tasks that are to be processed by the GPU 200, for example vertex shader tasks ‘D1’, ‘D2’, ‘D3’ and ‘D4’.

A right side of the graph may represent tasks processed by each of the unified shaders ‘US0’, ‘US2’ and ‘US3’ over time.

In FIG. 5, a single unified shader may process, in parallel, a vertex shader task and a pixel shader task, at a time. The job manager 210 may assign a next vertex shader task to a unified shader that does not execute a vertex shader task, among the unified shaders ‘US0’ through ‘US3’. Additionally, the job manager 210 may assign a next pixel shader task to a unified shader that does not execute a pixel shader task, among the unified shaders ‘US0’ through ‘US3’.

For example, when the unified shaders ‘US0’ through ‘US3’ execute pixel shader tasks ‘T1’, ‘T2’, ‘T3’, and ‘T4,’ respectively, the job manager 210 may assign the vertex shader tasks ‘D1’ through D4’ to the unified shaders ‘US0’ through ‘US3’, respectively. Additionally, when the unified shader ‘D3’ completes, first, execution of the pixel shader task ‘T2’ assigned to the unified shader ‘D3’, the job manager 210 may assign a next task, namely, a pixel shader task ‘T5’ to the unified shader ‘D3’.

By the above assignment, in a single unified shader, a vertex shader task and a pixel shader task may overlap and may be executed, and an occurrence of a bubble may be prevented. However, when one of a pixel shader task and a vertex shader task does not remain any more, a unified shader may process only a single task, and a bubble may occur.

Load balancing provided by the job manager 210 may refer to assigning a pixel shader task and a vertex shader task to a single unified shader at a time. Due to the load balancing, a stall of a pipeline may be minimized.

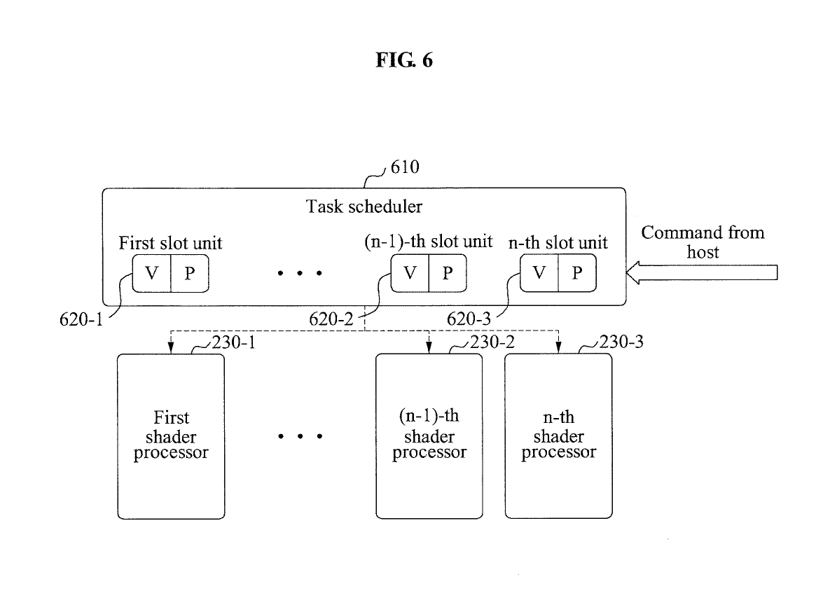

FIG. 6 illustrates a diagram of a task scheduler 610 using slots according to example embodiments.

The job manager 210 of FIG. 2 may execute the task scheduler 610. The task scheduler 610 may store, as data, at least one slot unit. The job manager 210 may manage the at least one slot unit. A command input by a host may be transferred to the task scheduler 610 through the job manager 210.

Each of the at least one slot unit may store a state of a shader processor among the at least one shader processor of FIG. 2.

The at least one slot unit of FIG. 6 may include, for example, a first slot unit 620-1, an (n−1)-th slot unit 620-2, and an n-th slot unit 620-3. As described above, the at least one shader processor may include, for example, the first shader processor 230-1, the (n−1)-th shader processor 230-2, the n-th shader processor 230-3, and the like. In this instance, ‘n’ may denote a number of shader processors and a number of slot units corresponding to the shader processers, and may be an integer that is greater than ‘1.’

For example, the first slot unit 620-1, the (n−1)-th slot unit 620-2 and the n-th slot unit 620-3 may store data of a state of the first shader processor 230-1, a state of the (n−1)-th shader processor 230-2, and a state of the n-th shader processor 230-3, respectively. In this instance, a state of each of the at least one shader processor may refer to a type of task executed by each of the at least one shader processor. In other words, the at least one slot unit may record the type of the task executed by the at least one shader processor.

Each of the at least one slot unit may include a first slot and a second slot. In FIG. 6, the first slot and the second slot may be represented by ‘V’ and ‘P’, respectively. The first slot may indicate whether a shader processor executes a vertex shader task, or whether a vertex shader task assigned to the shader processor exists. The second slot may indicate whether a shader processor executes a pixel shader task, or whether a pixel shader task assigned to the shader processor exists. The vertex shader task and the pixel shader task may be separately managed by the first slot and the second slot.

The first slot and the second slot may each have a Boolean value. For example, a first slot having a value of ‘0’ may indicate that a shader processor corresponding to the first slot is in the idle state in processing of a vertex shader task. Additionally, a first slot having a value of ‘1’ may indicate that a shader processor corresponding to the first slot is in a busy state in processing of a vertex shader task. A second slot having a value of ‘0’ may indicate that a shader processor corresponding to the second slot is in the idle state in processing of a pixel shader task. In addition, a second slot having a value of ‘1’ may indicate that a shader processor corresponding to the second slot is in the busy state in processing of a pixel shader task.

The job manager 210 may check information regarding a state of each of the at least one shader processor, using a value stored in the at least one slot unit. Based on a result of the checking, the job manager 210 may assign a next vertex shader task to a shader processor that does not process a vertex shader task, and may assign a next pixel shader task to a shader processor that does not process a pixel shader task.

The job manager 210 may assign a vertex shader task to a shader processor, and may update a value of a first slot of a slot unit corresponding to the shader processor with a value indicating that the shader processor currently processes the vertex shader task. Additionally, the job manager 210 may assign a pixel shader task to a shader processor, and may update a value of a second slot of a slot unit corresponding to the shader processor with a value indicating that the shader processor currently processes the pixel shader task.

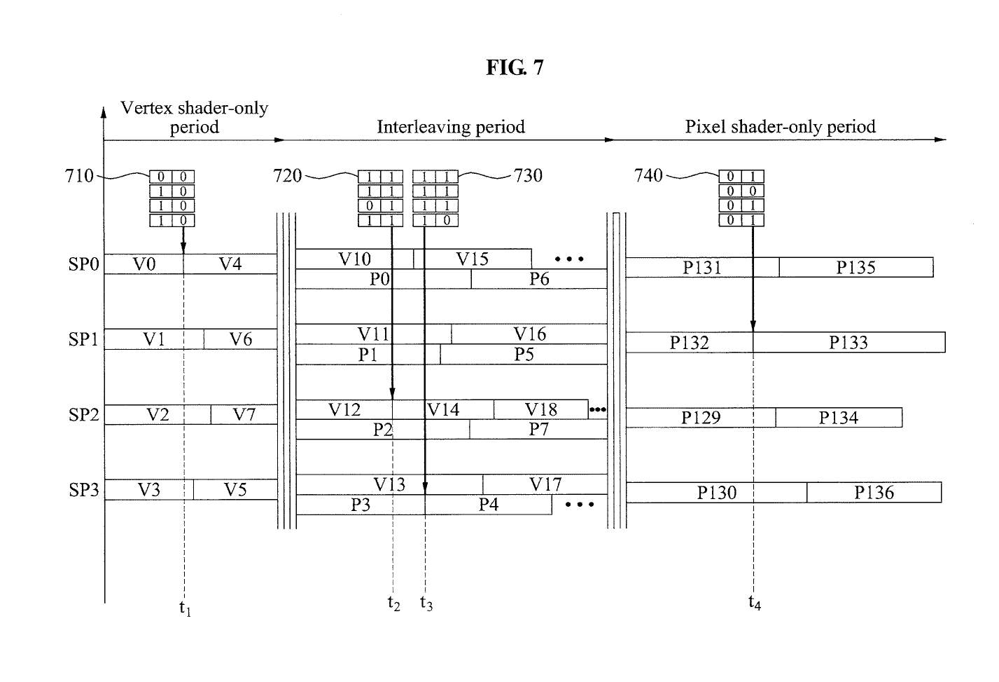

FIG. 7 illustrates a graph of task scheduling using slots according to example embodiments.

In the graph of FIG. 7, a y-axis may represent shader processors, for example four shader processors ‘SP0’, ‘SP1’, ‘SP2’ and ‘SP3’, and an x-axis may represent passage of time.

Time slots in the graph may be classified into a vertex shader-only period, an interleaving period, and a pixel shader-only period. The vertex shader-only period may refer to a time slot in which only a vertex shader task is executed by shader processors. The interleaving period may refer to a time slot in which a vertex shader task and a pixel shader task are interleaved and executed by at least one of shader processors. The pixel shader-only period may refer to a time slot in which only a pixel shader task is executed by shader processors.

In the graph of FIG. 7, a horizontal bar may represent a task. Specifically, ‘V’ in a bar may represent a vertex shader task, and a numeral next to ‘V’ may represent a number of a vertex shader task. Additionally, ‘P’ may represent a pixel shader task.

FIG. 7 also shows states 710, 720, 730 and 740 of slot units in times ‘t₁’, ‘t₂’, ‘t₃’ and ‘t₄’. A first column of each of the states 710 through 740 may represent a first slot, and a second column of each of the states 710 through 740 may represent a second slot. Rows of each of the states 710 through 740 may represent slot units respectively corresponding to the shader processors ‘SP0’ through ‘SP3’ from top to bottom. In this instance, a slot unit corresponding to a shader processor may represent a state of the shader processor.

Based on the state 710 in the time ‘t₁,’ the shader processor ‘SP0’ may be in the idle state in association with a vertex shader task. Accordingly, the job manager 210 of FIG. 2 may assign a next vertex shader task, namely ‘V4’, to the shader processor ‘SP0.’

Based on the state 720 in the time ‘t₂’, the shader processor ‘SP2’ may be in the idle state in association with a vertex shader task. Accordingly, the job manager 210 may assign a next vertex shader task, namely ‘V14’, to the shader processor ‘SP2.’

Based on the state 730 in the time ‘t₃’, the shader processor ‘SP3’ may be in the idle state in association with a pixel shader task. Accordingly, the job manager 210 may assign a next pixel shader task, namely ‘P4’, to the shader processor ‘SP3.’

Based on the state 740 in the time ‘t₄’, the shader processor ‘SP2’ may be in the idle state in association with a pixel shader task. Accordingly, the job manager 210 may assign a next pixel shader task, namely ‘P133’, to the shader processor ‘SP2.’

By the above-described assignment, the job manager 210 may perform dynamic load balancing so that different tasks may exist in a single shader processor. The dynamic load balancing may improve a throughput of a GPU based on multi-cores and a unified shader.

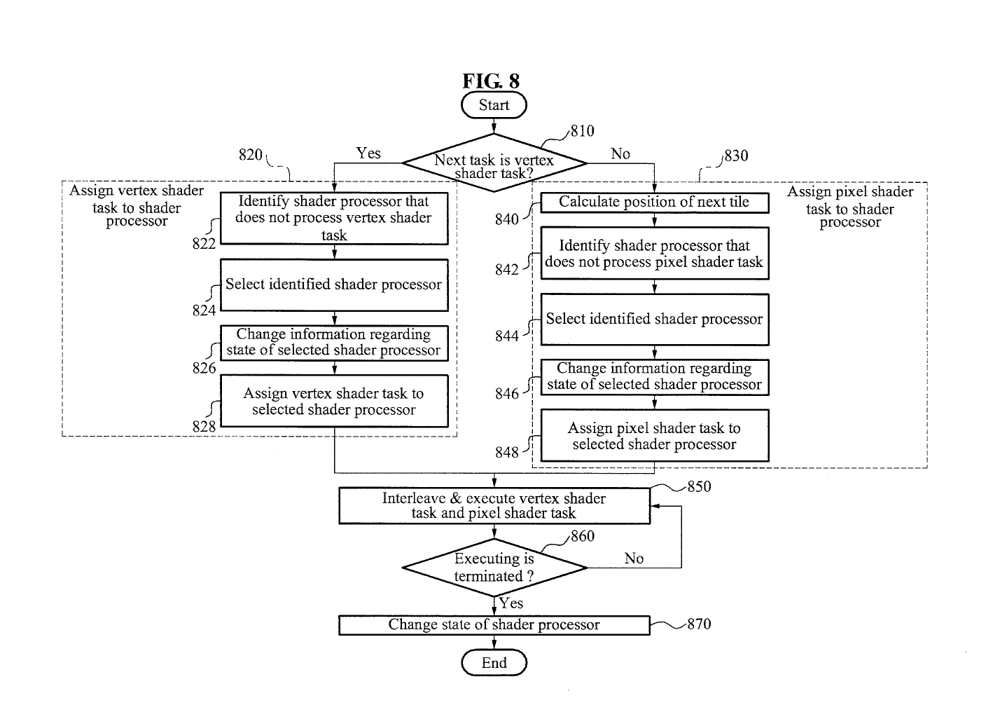

FIG. 8 illustrates a flowchart of a graphic processing method according to example embodiments.

In operation 810, the job manager 210 may determine whether a next task is a vertex shader task or a pixel shader task. When the next task is determined to be the vertex shader task, operation 820 may be performed. Conversely, when the next task is determined to be the pixel shader task, operation 830 may be performed.

In operation 820, the job manager 210 may assign the vertex shader task to the shader processor 100.

In operation 830, the job manager 210 may assign the pixel shader task to the shader processor 100.

In operation 850, the shader processor 100 may interleave and execute the assigned vertex shader task and the assigned pixel shader task.

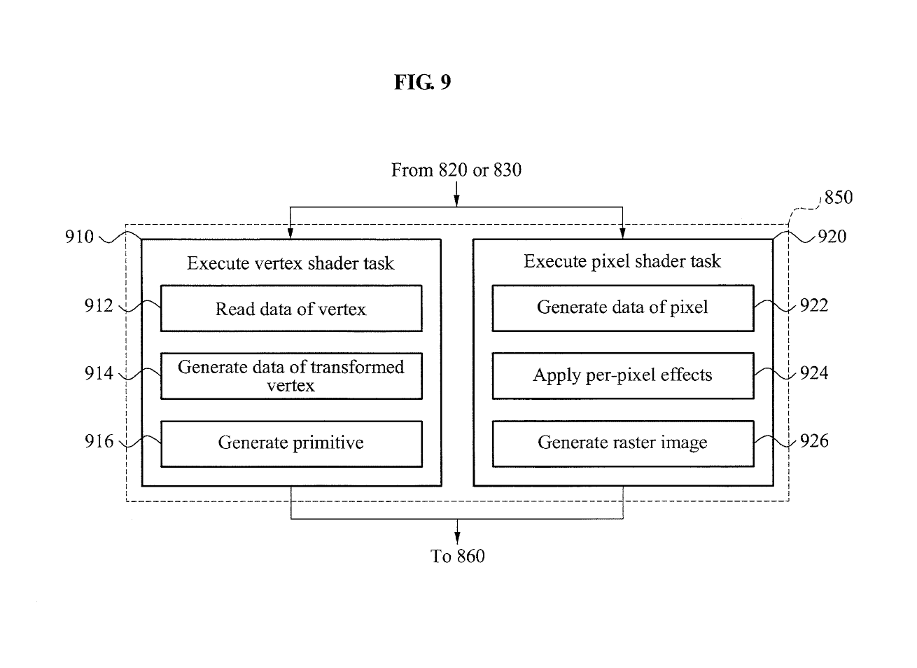

Operation 850 will be further described with reference to FIG. 9 later.

In operation 860, the shader processor 100 or the job manager 210 may determine whether execution of the assigned vertex shader task and execution of the assigned pixel shader task are terminated. When the execution of the assigned vertex shader task or the execution of the assigned pixel shader task is not terminated, operation 850 may be repeatedly performed. Conversely, when the execution of the assigned vertex shader task and the execution of the assigned pixel shader task are terminated, operation 870 may be performed.

In operation 870, the job manager 210 may change a state of the shader processor 100. To change the state of the shader processor 100, the job manager 210 may change a value of data indicating the state of the shader processor 100.

A plurality of shader processors may be provided. In operations 820, 830, 850, and 860, the shader processor 100 may be selected by the job manager 210 from among the plurality of shader processors, as a shader processor that may process the next task.

Operation 820 may include operations 822, 824, 826 and 828.

In operation 822, the job manager 210 may identify a shader processor that does not process a vertex shader task, from among the shader processors, by checking information regarding states of the shader processors. In this instance, the information may refer to values of first slots of slot units corresponding to the shader processors.

In operation 824, the job manager 210 may select the identified shader processor.

In operation 826, the job manager 210 may change information regarding a state of the selected shader processor, so that the changed information may indicate that the selected shader processor processes the vertex shader task. The job manager 210 may set a value of a first slot of a slot unit corresponding to the selected shader processor, to a value indicating ‘busy’.

In operation 828, the job manager 210 may assign the vertex shader task to the selected shader processor. The job manager 210 may transmit data of the next task to the selected shader processor.

Operation 830 may include operations 840, 842, 844, 846 and 848.

In operation 840, the tile dispatch unit 220 may calculate a position of a next tile. In this instance, a position of a tile may refer to coordinates of the tile, or a start point of the tile. To calculate a position of a next tile may mean to identify a tile which is the next task to be processed by the pixel shader task.

In operation 842, the job manager 210 may identify a shader processor that does not process a pixel shader task, from among a plurality of shader processors, by checking information regarding states of the shader processors. In this instance, the information may refer to values of second slots of slot units corresponding to the shader processors.

In operation 844, the job manager 210 may select the identified shader processor.

In operation 846, the job manager 210 may change information regarding a state of the selected shader processor, so that the changed information may indicate that the selected shader processor processes the pixel shader task. The job manager 210 may set a value of a second slot of a slot unit corresponding to the selected shader processor, to a value indicating ‘busy’.

In operation 828, the job manager 210 may assign the pixel shader task to the selected shader processor. The job manager 210 may transmit data of the next task to the selected shader processor. The tile dispatch unit 220 may transmit data of the next tile to the selected shader processor, under the control of the job manager 210.

Technical information described above with reference to FIGS. 1 through 7 may equally be applied to the present embodiment, and accordingly further description thereof will be omitted.

FIG. 9 illustrates a flowchart of operation 850 of FIG. 8.

In operation 910, the shader processor 100 may execute the vertex shader task.

Operation 910 may include operations 912, 914 and 916.

In operation 912, the vertex loader 110 of the shader processor 100 may read data of a vertex.

In operation 914, the unified shader 130 of the shader processor 100 may transform, based on the data of the vertex, a 3D position of the vertex to a depth value and 2D coordinates, and may generate data of the transformed vertex.

In operation 916, the primitive assembly 150 of the shader processor 100 may generate a primitive, based on the data of the transformed vertex.

In operation 920, the shader processor 100 may execute the pixel shader task.

Operation 920 may include operations 922, 924 and 926.

In operation 922, the fragment generator 120 of the shader processor 100 may generate data of a pixel included in an object, based on data of the object. In this instance, the object may include, for example, a primitive.

In operation 924, the unified shader 130 may apply per-pixel effects to the generated data of the pixel.

In operation 926, a raster operator of the shader processor 100 may generate a raster image, based on the data of the pixel.

The shader processor 100 may execute the vertex shader task and the pixel shader task through a plurality of pipeline stages. In other words, operations 912, 914, 916, 922, 924, and 926 may be performed in parallel, through the pipeline stages. The pipeline stages may each process the assigned vertex shader task or the assigned pixel shader task.

Technical information described above with reference to FIGS. 1 through 8 may equally be applied to the present embodiment, and accordingly further description thereof will be omitted.

Any one or more of the software modules or units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor, a graphic processing unit (GPU), a core of a GPU, or any other device capable of responding to and executing instructions in a defined manner. The units may be executed by a dedicated processor unique to that unit or by a processor common to one or more of the units. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A graphic processing unit (GPU), comprising:
at least one shader processor operated as both a vertex shader and a pixel shader; and
a job manager to assign a vertex shader task and a pixel shader task to the at least one shader processor,
wherein each of the at least one shader processor interleaves and executes the assigned vertex shader task and the assigned pixel shader task.

2. The GPU of claim 1, wherein each of the at least one shader processor processes a task through a plurality of pipeline stages, and
wherein the plurality of pipeline stages each process the assigned vertex shader task or the assigned pixel shader task.

3. The GPU of claim 2, wherein each of the at least one shader processor comprises:
a vertex loader to read data of a vertex;
a fragment generator to generate data of a pixel included in an object, based on data of the object;
a unified shader to transform, based on the data of the vertex, a three-dimensional (3D) position of the vertex to a depth value and two-dimensional (2D) coordinates, to generate data of the transformed vertex, and to apply per-pixel effects to the data of the pixel;
a primitive assembly to generate a primitive, based on the data of the transformed vertex; and
a raster operator to generate a raster image, based on the data of the pixel, and
wherein each of the plurality of pipeline stages is provided by at least one of the vertex loader, the fragment generator, the unified shader, the primitive assembly, and the raster operator.

4. The GPU of claim 1, wherein the vertex shader task is a task divided in a drawcall unit, and the pixel shader task is a task divided in a tile unit.

5. The GPU of claim 1, further comprising:
a tile dispatch unit to transmit data of an object in a tile to the at least one shader processor.

6. The GPU of claim 1, further comprising:
a tile binning unit to divide a frame into tiles.

7. The GPU of claim 1, wherein the job manager manages at least one slot unit configured to store a state of each of the at least one shader processor, and
wherein the at least one slot unit records a type of a task executed by each of the at least one shader processor.

8. A graphic processing method, comprising:
assigning, by a job manager, a vertex shader task to a shader processor;
assigning, by the job manager, a pixel shader task to the shader processor; and
interleaving and executing, by the shader processor, the assigned vertex shader task and the assigned pixel shader task.

9. The graphic processing method of claim 8, wherein the shader processor processes a task through a plurality of pipeline stages, and
wherein the plurality of pipeline stages each process the assigned vertex shader task or the assigned pixel shader task.

10. The graphic processing method of claim 8, wherein the interleaving and executing comprises:
reading, by a vertex loader of the shader processor, data of a vertex;
transforming, by a unified shader of the shader processor, based on the data of the vertex, a three-dimensional (3D) position of the vertex to a depth value and two-dimensional (2D) coordinates, and generating data of the transformed vertex;
generating, by a primitive assembly of the shader processor, a primitive, based on the data of the transformed vertex;
generating, by a fragment generator of the shader processor, data of a pixel included in an object, based on data of the object;
applying, by the unified shader, per-pixel effects to the data of the pixel; and
generating, by a raster operator of the shader processor, a raster image, based on the data of the pixel.

11. The graphic processing method of claim 8, wherein a plurality of shader processors are provided, and
wherein the assigning of the vertex shader task comprises:
selecting, by the job manager, a shader processor, from among the plurality of shader processors, which is not currently processing a vertex shader task; and
assigning, by the job manager, the vertex shader task to the selected shader processor.

12. The graphic processing method of claim 11, wherein the assigning of the vertex shader task further comprises:
identifying, by the job manager, a shader processor that is not currently processing a vertex shader task, from among the plurality of shader processors, by checking information regarding states of the plurality of shader processors; and
changing, by the job manager, information regarding a state of the selected shader processor, so that the changed information indicates that the selected shader processor currently processes the vertex shader task.

13. The graphic processing method of claim 8, wherein a plurality of shader processors are provided, and
wherein the assigning of the pixel shader task comprises:
selecting, by the job manager, a shader processor that is not currently processing a pixel shader task, from among the plurality of shader processors; and
assigning, by the job manager, the pixel shader task to the selected shader processor.

14. The graphic processing method of claim 13, wherein the assigning of the pixel shader task further comprises:
identifying, by the job manager, a shader processor that is not currently processing a pixel shader task, from among the plurality of shader processors, by checking information regarding states of the plurality of shader processors; and
changing, by the job manager, information regarding a state of the selected shader processor, so that the changed information indicates that the selected shader processor currently processes the pixel shader task.

15. A non-transitory computer readable recording medium storing a program to cause a computer to implement the method of claim 8.

16. A shader processor, comprising:
a vertex loader to read data of a vertex;
a fragment generator to generate data of a pixel included in an object, based on data of the object;
a unified shader to transform, based on the data of the vertex, a three-dimensional (3D) position of the vertex to a depth value and two-dimensional (2D) coordinates, to generate data of the transformed vertex, and to apply per-pixel effects to the data of the pixel;
a primitive assembly to generate a primitive, based on the data of the transformed vertex; and
a raster operator to generate a raster image, based on the data of the pixel.

17. The shader processor of claim 16, being configured to process a task through a plurality of pipeline stages,
wherein the plurality of pipeline stages each process a vertex shader task or a pixel shader task.

18. The shader processor of claim 17, wherein each of the plurality of pipeline stages is provided by at least one of the vertex loader, the fragment generator, the unified shader, the primitive assembly, and the raster operator.

19. The shader processor of claim 16, wherein the shader processor is configured to operate as both a vertex shader and a pixel shader.

20. A shader processor configured to operate as both a vertex shader and a pixel shader, wherein the shader processor comprises a core of a graphic processing unit and is controlled to interleave and execute an assigned vertex shader task and an assigned pixel shader task.

21. A graphic processing unit (GPU), comprising:
a first shader processor and a second shader processor, each operated as both a vertex shader and a pixel shader; and
a job manager to interleave tasks by assigning either of a vertex shader task and a pixel shader task to whichever of the first shader processor and the second shader processor is idle.
